(19) United States
(12) Patent Application Publication
(10) Pub. No.: US 2010/0107098 A1
(43) Pub. Date: Apr. 29, 2010

(54) Identification Method for an Electronic System and Related Electronic System

(76) Inventor: Chin-Yu Wang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/464,865

(22) Filed: May 12, 2009

(30) Foreign Application Priority Data
Oct. 23, 2008 (TW) 097140667

(51) Int. Cl. G06F 3/048; G09G 5/00

(52) U.S. Cl. 715/764; 345/156

(57) ABSTRACT

An identification method for an electronic system having a plurality of input devices includes establishing notations corresponding to the plurality of input devices, receiving a control signal outputted by a specific input device of the plurality of input devices, and displaying a notation corresponding to the specific input device on a display device.

### BACKGROUND OF THE INVENTION

1. Field of the Invention

The present invention relates to an identification method for an electronic system and related electronic system, and more particularly, to an identification method, related electronic system capable of enhancing usage convenience.

2. Description of the Prior Art

With technological advancement, various electronic apparatuses have multiple functions. The same electronic apparatus, such as a computer system, a portable electronic apparatus, or an information appliance, can usually be controlled through different input interfaces. Taking a computer system for example, a user can input a control command or data content via an input device, such as a keyboard, a mouse, a touch pad, an image capturing device, a microphone, etc., for controlling or accessing data of the computer system.

However, for such an electronic device having multiple input devices, the user can not distinguish immediately whether a signal they inputted to the electronic device through an input device was inputted successfully, so that the user often repeats input of the control commands or data contents. Especially, when the input device communicates with the electronic device wirelessly, the above-mentioned problem may easily cause inconvenience for the user. For example, the user may press a media player hot key of a wireless keyboard for activating media player software, and if the electronic device does not respond at once, the user may not be able to determine whether the input signal was not received by the electronic device or the electronic device has an unknown software exception. Therefore, the user repeats pressing the hot key to lead the software to shut down, and thus causing inconvenience to the user. Moreover, if multiple users use the same type of input device to input signals at the same time, sometimes the input signals may not be processed. For example, the electronic device may only process an input signal of the keyboard at one time. In such a condition, if more than two keyboards operate simultaneously, the keyboards not processed may be unable to control the electronic device or solve problems. Therefore, under the multiple user scheme using multiple input devices, each user may blindly input their signal, and be unable to ensure valid input. And, even if the user is able to determine that the input signal was not received by the electronic device, the user still needs to input the signal again, thus causing inconvenience for the user.

In short, in the multiple user scheme using multiple input devices, each user may blindly input their signal and be unable to ensure valid input. Even if the user knows the input signal was not received by the electronic device, the user still needs to input the signals again, thus causing inconvenience for the user.

### SUMMARY OF THE INVENTION

The present invention discloses an identification method for an electronic system having a plurality of input devices, which comprises establishing notations corresponding to the plurality of input devices, receiving a control signal outputted by a specific input device of the plurality of input devices, and displaying a notation corresponding to the specific input device on a display device.

The present invention further discloses an electronic system with identification device, which comprises a plurality of input devices, an establishing unit for establishing notations corresponding to the plurality of input devices, a receiving unit for receiving a control signal outputted by a specific input device of the plurality of input devices, and a logic unit coupled to the establishing unit and the receiving unit for displaying a notation of the plurality of notations corresponding to the specific input device on the display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic system according to an embodiment of the present invention.

FIG. 2 is a schematic diagram of a procedure according to an embodiment of the present invention.

FIG. 3 is a schematic diagram of an input device notation table of the establishing unit shown in FIG. 1 according to an embodiment of the present invention.

FIG. 4 is a schematic diagram of displaying a notation of a computer system according to an embodiment of the present invention.

### DETAILED DESCRIPTION

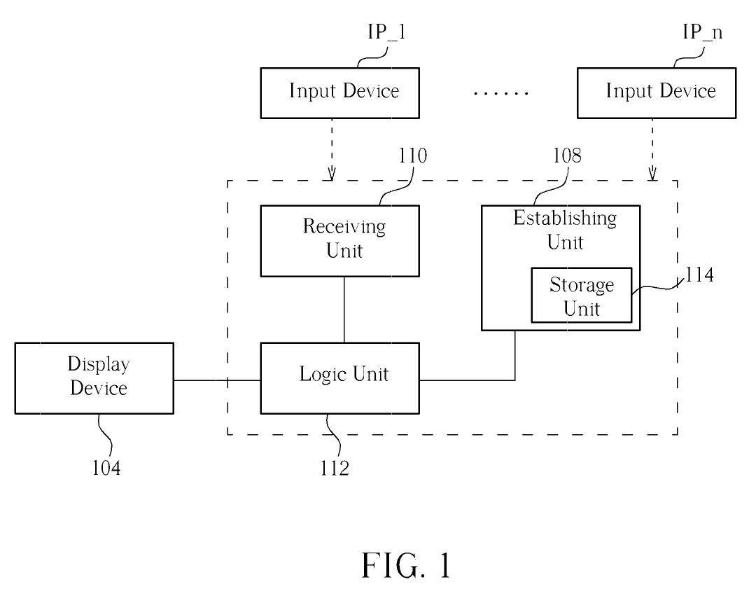

Please refer to FIG. 1. FIG. 1 is a schematic diagram of an electronic system 10 according to an embodiment of the present invention. The electronic system 10 includes input devices IP_1-IP_n, a display device 104, an establishing unit 108, a receiving unit 110, and a logic unit 112. The electronic system 10 is preferably a computer system, such as a desktop computer, notebook, personal digital assistant, smart phone, information appliance, etc., which are not limitations of the present invention. The input devices IP_1-IP_n input control commands or data contents to the electronic system 10 through a wired or wireless connection, and can be a keyboard, a mouse, a touch pad, an image capture device, a microphone, etc., which are not limitations of the present invention. The establishing unit 108 is utilized for establishing notations X_1-X_n corresponding to the input devices IP_1-IP_n according to information of the input devices IP_1-IP_n. Also, the establishing unit 108 further includes a storage unit 114 for storing the notations X_1-X_n or other related information. The receiving unit 110 is utilized for receiving a control signal outputted by a specific input device of the input devices IP_1-IP_n. The logic unit 112 is coupled to the establishing unit 108, the receiving unit 110, and the display device 104 for displaying a notation of the notations X_1-X_n corresponding to the specific input device on the display device. In detail, the logic unit 112 determines the source of the control signal according to the control signal received by the receiving unit 110 so as to display the notation corresponding to the source of the control signal via the display device 104. Thus, in the electronic system 10, a user is capable of effectively ensuring operation status of input devices IP_1-IP_n and usage status of other input devices for avoiding uncertainly factors and enhancing usage convenience.

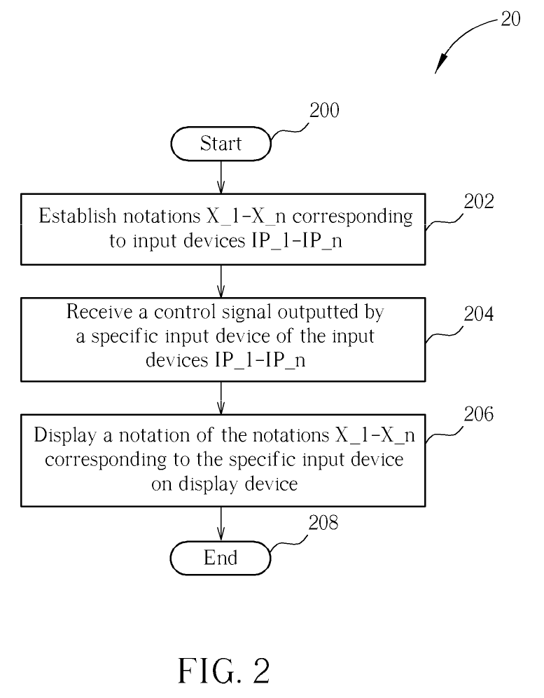

As to an operating procedure of the electronic system 10 shown in FIG. 1, please refer to FIG. 2. FIG. 2 is a schematic diagram of a procedure 20 according to an embodiment of the present invention. The procedure 20 comprises the following steps:

Step 200: Start.

Step 202: Establish notations X_1-X_n corresponding to input devices IP_1-IP_n.

Step 204: Receive a control signal outputted by a specific input device of the input devices IP_1-IP_n.

Step 206: Display a notation of the notations X_1-X_n corresponding to the specific input device on the display device.

Step 208: End.

According to the procedure 20, the present invention first establishes notations X_1-X_n corresponding to input devices IP_1-IP_n. After receiving a control signal outputted by a specific input device of the input devices IP_1-IP_n, the electronic system 10 displays a notation of the notations X_1-X_n corresponding to the specific input device on the display device 104. In other words, when a user inputs a signal by input devices IP_1-IP_n. The present invention can display notations corresponding to input devices IP_1-IP_n through the above-mentioned method immediately so as to show all users which input device is being used for avoiding uncertainty factors and enhancing usage convenience.

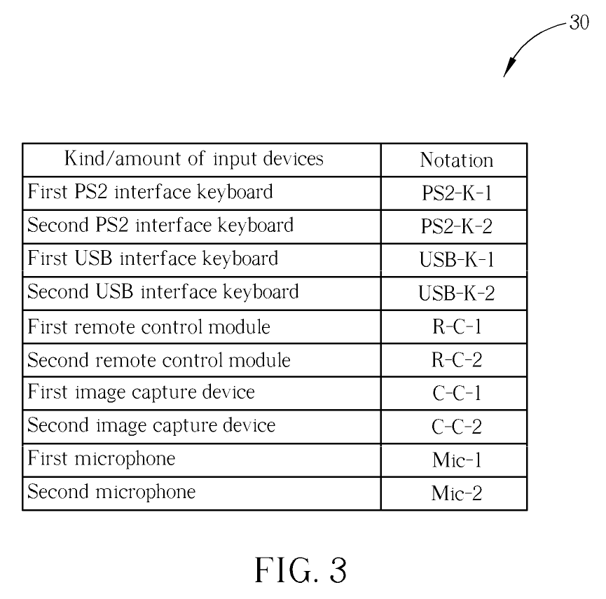

Note that, the electronic system 10 is an exemplary embodiment of the present invention, and those skilled in the art can make alternations and modifications accordingly. For example, the establishing unit 108 is capable of establishing the notations X_1-X_n corresponding to input devices IP_1-IP_n according to kinds and amounts of the input devices IP_1-IP_n. Please refer to FIG. 3. FIG. 3 is a schematic diagram of an input device notation table 30 of the establishing unit 108 shown in FIG. 1 according to an embodiment of the present invention. In the input device notation table 30, the first column represents kinds or amounts of the input device, and the second column represents notations of the input device corresponding to the first column. For example, the notation of the first PS2 interface keyboard is PS2-K-1; the notation of the second PS2 interface keyboard is PS2-K-2, and so on. The input device notation table 30 is an exemplary embodiment of the present invention, so that any type or kind of notations which can be quickly and correctly identified by the user is suitable. In addition, preferably, the logic unit 112 is capable of displaying the notations on the display device 104 for a predetermined time or displaying the notations on the display device 104 following a specific rule. For example, the notations may be displayed continuously for 5 seconds, or for 3 seconds every 3-second interval. Furthermore, the logic unit 112 further adjusts the predetermined time of displaying the notations according to a user control command, so as to show all users which input device is being used through the display device 104.

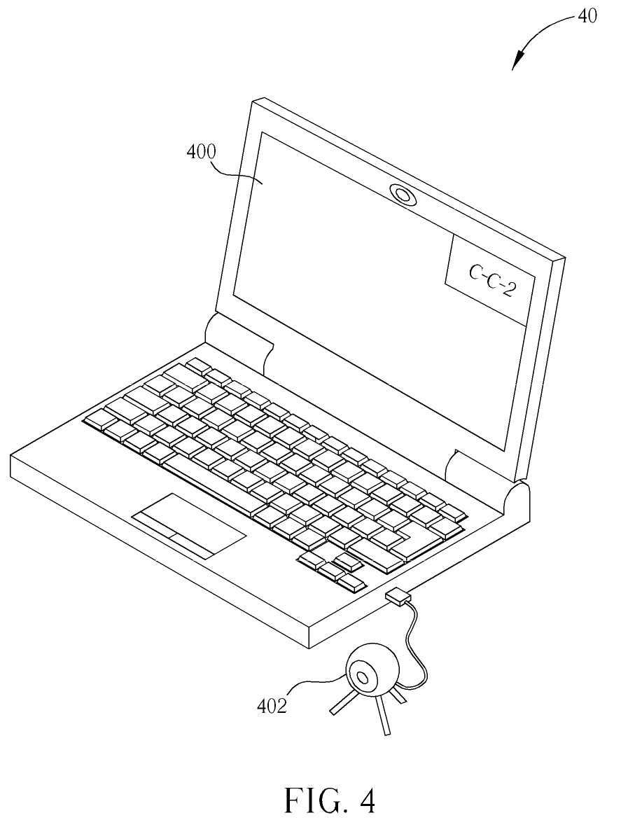

In addition, the logic unit 112 displays graphics corresponding to the notations X_1-X_n on the display device 104 with graphical representation. Any type of display method can be utilized for clearly understanding graphics corresponding to the notations X_1-X_n from the display device 104 by the user. For example, please refer to FIG. 4. FIG. 4 is a schematic diagram of displaying a notation of a computer system 40 according to an embodiment of the present invention. The computer system 40 is designed according to the electronic system 10 shown in FIG. 1, which can display notations corresponding to different input devices based on the input device notation table 30 shown in FIG. 3. In FIG. 4, the computer system 40 displays the graph indicating notation “C-C-2” corresponding to an image capture device 402 through a picture-in-picture (PiP) or picture-out-of-picture (PoP) method via a display monitor 400. After that, the user can understand that the image capture device 402 is in operation.

Note that, FIG. 1 to FIG. 4 are used to illustrate the present invention, but are not limitations of the present invention, and those skilled in the art can make alternations and modifications accordingly.

In summary, for an electronic system having multiple input devices, the embodiments of the present invention can immediately display notations corresponding to in-use input devices so as to show which input device is being used for avoiding uncertainty factors and enhancing convenience of use.

Those skilled in the art will readily observe that numerous modifications and alterations of the device and method may be made while retaining the teachings of the invention.

What is claimed is:

1. An identification method for an electronic system having a plurality of input devices, comprising:
establishing notations corresponding to the plurality of input devices;
receiving a control signal outputted by a specific input device of the plurality of input devices; and
displaying a notation corresponding to the specific input device on a display device.

2. The identification method of claim 1, wherein establishing notations corresponding to the plurality of input devices is according to kinds and amounts of the plurality of input devices.

3. The identification method of claim 1, wherein establishing notations corresponding to the plurality of input devices further comprises storing the notations in a storage unit.

4. The identification method of claim 1, wherein displaying the notation corresponding to the specific input device on the display device is displaying graphics corresponding to the notation on the display device with graphical representation.

5. The identification method of claim 1, wherein displaying the notation corresponding to the specific input device on the display device is displaying the notation on the display device for a predetermined time.

6. The identification method of claim 5, further comprising adjusting the predetermined time according to a user control command.

7. An electronic system with an identification device, the electronic system comprising:
a plurality of input devices;
an establishing unit for establishing notations corresponding to the plurality of input devices;
a receiving unit for receiving a control signal outputted by a specific input device of the plurality of input devices; and
a logic unit coupled to the establishing unit and the receiving unit for displaying a notation corresponding to the specific input device on a display device.

8. The electronic system of claim 7, wherein the establishing unit establishes the plurality of notations corresponding to the plurality of input devices according to kinds and amounts of the plurality of input devices.

9. The electronic system of claim 7, wherein the establishing unit comprises a storage unit for storing the plurality of notations.

10. The electronic system of claim 7, wherein the logic unit displays graphics corresponding to the notation on the display device with graphical representation.

11. The electronic system of claim 7, wherein the logic unit displays the notation on the display device for a predetermined time.

12. The electronic system of claim 11, wherein the logic unit is further utilized for adjusting the predetermined time according to a user control command.
